(19) United States
(12) Patent Application Publication
(10) Pub. No.: US 2016/0063548 A1
(43) Pub. Date: Mar. 3, 2016

(54) Selecting Alternative Content Based on Content Presented to a User of an Online System

(71) Applicant: Facebook, Inc., Menlo Park, CA (US)

(72) Inventors: Fidji Nahema Simo, Palo Alto, CA (US); Asad K. Awan, San Francisco, CA (US); Jessica Marie Watson, San Francisco, CA (US)

(21) Appl. No.: 14/473,975

(22) Filed: Aug. 29, 2014

(51) Int. Cl. G06Q 30/02; G06Q 30/06

(52) U.S. Cl. CPC G06Q 30/0255; G06Q 30/0277; G06Q 30/0631

(57) ABSTRACT

An online system allows an advertiser to specify an advertisement (“ad”) request including information describing multiple products, where one of the products was previously presented to a user of the online system to be presented with the ad request. The additional products included in the ad request are selected based on a measure of their relevance to the product included in the ad request. An advertiser provides the online system with an identity of the user and the product previously presented to the user. The one or more additional products may be specified by the advertiser, may be selected by the online system from a product catalog of the advertiser, or may be selected based on their relevance scores with the product previously presented to the user.

### BACKGROUND

This disclosure relates generally to online systems, and more specifically to providing an online system user with content including content with which the user has previously interacted and additional content.

An online system, such as a social networking system, allows its users to connect to and communicate with other online system users. Users may create profiles on an online system that are tied to their identities and include information about the users, such as interests and demographic information. The users may be individuals or entities such as corporations or charities. Because of the increasing popularity of online systems and the increasing amount of user-specific information maintained by online systems, an online system provides an ideal forum for entities, such as retailers or service providers, to increase awareness about products or services by presenting content to online system users.

Presenting content items to online system users allows an entity (e.g., a retailer, a service provider, a restaurant) to gain public attention for products or services or to persuade online users to take an action regarding the entity's products or services. Additionally, many online systems generate revenue by receiving compensation from entities for presenting certain content items to their users. Frequently, online systems charge an entity for each presentation of certain types of content items to an online system user (e.g., each “impression” of the content item) or for each interaction with certain types of content items by an online system user.

Conventionally, an entity provides a content item describing a product or a service to an online system. The content item includes information describing the product or the service for presentation to online system users. A conventional online system typically presents a large number of content items describing products or services to its users during various time intervals. However, presenting a large number of content items describing a product or a service to online system users may dissuade the users from reviewing or interacting with the content items describing products or services.

### SUMMARY

An online system receives an advertisement (“ad”) request including targeting criteria and ad content from an advertiser. The targeting criteria include information identifying a user of the online system. For example, the information identifying a user of the online system can be information associated with the user's user profile maintained by the online system, actions taken by the user or by connected users to the user in the online system, or a tracked cookie associated with the user. The ad content of the ad request includes information associated with a product or a service previously presented to the user by an entity associated with the advertiser and information associated with additional content. Additionally, the ad content may also include a link or other information for retrieving information about the product (e.g., a network address). Examples of the product or service previously presented to the user included in the ad content include an item sold by the advertiser, an item associated with the advertiser (e.g., sponsorship of the item), a service offered or provided by the advertiser, or any other suitable offer by the advertiser. Various characteristics are associated with the product or service by the online system or by the advertiser. Example characteristics of the product or service previously presented to the user include a name of the product or service, a price of the product or service, a manufacturer of the product, a provider of the service, a merchant or an advertiser selling the product or service, an entity associated with the advertiser, a type of product or service, a purpose of the product or service, features of the product, and performance of additional ad requests associated with the product or advertiser in the online system.

The ad content in the ad request also includes information associated with additional content. For example, the additional content is an additional product and the information associated with the additional content is information describing the content or a link to retrieve a description of the additional product or to view the additional product. Additional products or services described via the additional information may be determined after the ad request is received by the online system, so the information associated with the additional content acts as a placeholder for inclusion of information describing additional products to be presented to a user presented with the content.

When presenting the ad content from the ad request to a user corresponding to the information identifying the user in the ad request, the online system accesses information describing one or more additional products or services associated with the advertiser from which the ad request was received. For example, the online system retrieves characteristics, such as those described above, associated with various products that are associated with the advertiser from which the ad request was received. Each additional product is associated with a link or destination address to access the additional product or to access information describing the additional product.

The online system determines relevance scores between various additional products and the product. For example, the online system determines relevance scores between each additional product and the product. In one embodiment, a relevance score between the product and an additional product is based on a number of characteristics of the product matching, or similar to, characteristics of the additional product. Different weights may be associated with different characteristics of products, with the relevance score between a product and an additional product based on a combination of weights associated with characteristics of the product matching or similar to characteristics of the additional product. Weights may be associated with characteristics based on information provided by the advertiser, information included in a user profile associated with the user by the online system, prior actions associated with the user by the online system, or any other suitable information. Additional information may be used to determine the relevance score between the product and an additional product in other embodiments. Examples of additional information used to determine a relevance score include characteristics associated with the additional product matching objects maintained by the online system and connected to the user, characteristics associated with the additional product matching actions associated with the user, characteristics associated with the additional product matching attributes associated with the user by the online system, and information associated with additional users connected to the user via the online system.

Based at least in part on the relevance scores, the online system selects an alternative product from the one or more additional products. In one embodiment, the alternative product is selected as the additional product having the highest relevance score. Alternatively, the alternative product is selected as an additional product having at least a threshold relevance score. In some embodiments, the online system may select multiple alternative products from the additional products based on the relevance scores. For example, the online system ranks the additional products based at least in part on their relevance scores and selects alternative products as additional products having at least a threshold position in the ranking. In alternative embodiments, one or more alternative products are specified by the advertiser in the ad request or otherwise provided to the online system by the advertiser associated with the ad request.

The online system associates information associated with the alternative product with the additional content included in the ad content of the received ad request. Example information associated with the alternative product may be information describing the alternative product, one or more images associated with the alternative product, interactions associated with additional users of the online system connected to the user and associated with the additional product, a link or destination address for retrieving information associated with the alternative product, or any other suitable information. The online system presents the ad content including information associated with the product and the information associated with the alternative product to the user. For example, the presented ad content displays information describing the product and information describing the alternative product adjacent to each other. In one embodiment, the ad content is partitioned into tiles, with information describing the product presented in a tile and information describing the additional product in another tile. Alternatively, the ad content is presented via a scrollable interface, allowing the user to view information associated with the product or with the additional product by navigating through the scrollable user interface. For example, a link to retrieve information associated with the product and a link to retrieve information associated with the additional product are presented by the ad content.

### BRIEF DESCRIPTION OF THE DRAWINGS

FIG. 1 is a block diagram of a system environment in which an online system operates, in accordance with an embodiment.

FIG. 2 is a block diagram of an online system, in accordance with an embodiment.

FIG. 3 is a flowchart of a method for selecting an alternative product to include in advertisement content identifying a product with which an online system user was previously presented, in accordance with an embodiment.

FIG. 4 is an example of advertisement content displayed to an online system user, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

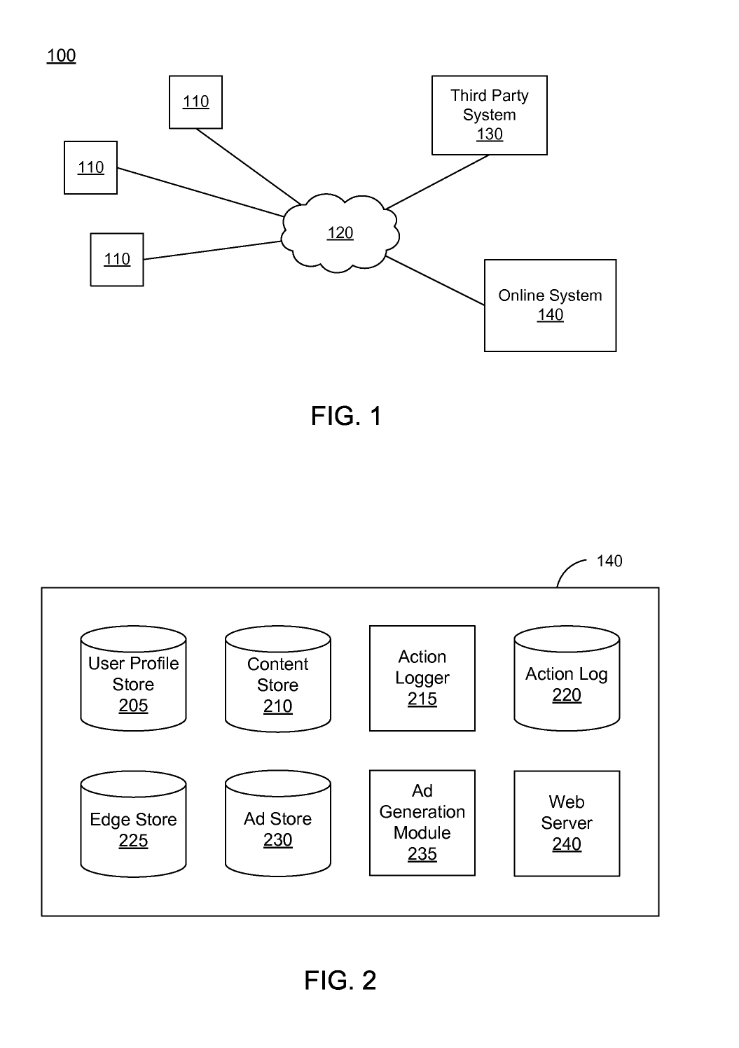

FIG. 1 is a high level block diagram of a system environment 100 for an online system 140, such as a social networking system. The system environment 100 shown by FIG. 1 comprises one or more client devices 110, a network 120, one or more third party systems 130, and the online system 140. In alternative configurations, different and/or additional components may be included in the system environment 100.

The client devices 110 are one or more computing devices capable of receiving user input as well as transmitting and/or receiving data via the network 120. In one embodiment, a client device 110 is a conventional computer system, such as a desktop or laptop computer. Alternatively, a client device 110 may be a device having computer functionality, such as a personal digital assistant (PDA), a mobile telephone, a smartphone or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the online system 140, which is further described below in conjunction with FIG. 2. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. A third party website 130 may also communicate information to the online system 140, such as advertisements, content, or information about an application provided by the third party website 130.

FIG. 2 is an example block diagram of an architecture of the online system 140. The online system 140 shown in FIG. 2 includes a user profile store 205, a content store 210, an action logger 215, an action log 220, an edge store 225, an advertisement (“ad”) store 230, an ad generation module 235, and a web server 240. In other embodiments, the online system 140 may include additional, fewer, or different components for various applications. Conventional components such as network interfaces, security functions, load balancers, failover servers, management and network operations consoles, and the like are not shown so as to not obscure the details of the system architecture. In one embodiment, the online system 140 is a social networking system.

Each user of the online system 140 is associated with a user profile, which is stored in the user profile store 205. A user profile includes declarative information about the user that was explicitly shared by the user and may also include profile information inferred by the online system 140. In one embodiment, a user profile includes multiple data fields, each describing one or more attributes of the corresponding user of the online system 140. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying users of the online system 140 displayed in an image. A user profile in the user profile store 205 may also maintain references to actions by the corresponding user performed on content items in the content store 210 and stored in the action log 220.

While user profiles in the user profile store 205 are frequently associated with individuals, allowing individuals to interact with each other via the online system 140, user profiles may also be stored for entities such as businesses or organizations. This allows an entity to establish a presence on the online system 140 for connecting and exchanging content with other online system users. The entity may post information about itself, about its products or provide other information to users of the online system using a brand page associated with the entity's user profile. Other users of the online system may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item (e.g., the content item from the online system 140, from a third party system 130), a gaming application achievement, a check-in event at a local business, a brand page, or any other type of content. Online system users may create objects stored by the content store 210, such as status updates, photos tagged by users to be associated with other objects in the online system, events, groups or applications. In some embodiments, objects are received from third-party applications or third-party applications separate from the online system 140. In one embodiment, objects in the content store 210 represent single pieces of content, or content “items.” Hence, online system users are encouraged to communicate with each other by posting text and content items of various types of media to the online system 140 through various communication channels. This increases the amount of interaction of users with each other and increases the frequency with which users interact within the online system 140.

The action logger 215 receives communications about user actions internal to and/or external to the online system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with those users as well and stored in the action log 220.

The action log 220 may be used by the online system 140 to track user actions on the online system 140, as well as actions on third party systems 130 that communicate information to the online system 140. Users may interact with various objects on the online system 140, and information describing these interactions is stored in the action log 220. Examples of interactions with objects include: commenting on posts, sharing links, and checking-in to physical locations via a mobile device, accessing content items, and any other suitable interactions. Additional examples of interactions with objects on the online system 140 that are included in the action log 220 include: commenting on a photo album, communicating with a user, establishing a connection with an object, joining an event, joining a group, creating an event, authorizing an application, using an application, expressing a preference for an object (“liking” the object) and engaging in a transaction. Additionally, the action log 220 may record a user's interactions with advertisements on the online system 140 as well as with other applications operating on the online system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the online system 140. For example, an e-commerce website may recognize a user of an online system 140 through a social plug-in enabling the e-commerce website to identify the user of the online system 140. Because users of the online system 140 are uniquely identifiable, e-commerce websites, such as in the preceding example, may communicate information about a user's actions outside of the online system 140 to the online system 140 for association with the user. Hence, the action log 220 may record information about actions users perform on a third party system 130, including webpage viewing histories, advertisements that were engaged, purchases made, and other patterns from shopping and buying.

In one embodiment, the edge store 225 stores information describing connections between users and other objects on the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system 140, sharing a link with other users of the online system 140, and commenting on posts made by other users of the online system 140.

In one embodiment, an edge may include various features each representing characteristics of interactions between users, interactions between users and objects, or interactions between objects. For example, features included in an edge describe rate of interaction between two users, how recently two users have interacted with each other, the rate or amount of information retrieved by one user about an object, or the number and types of comments posted by a user about an object. The features may also represent information describing a particular object or user. For example, a feature may represent the level of interest that a user has in a particular topic, the rate at which the user logs into the online system 140, or information describing demographic information about a user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's interest in an object, in a topic, or in another user in the online system 140 based on the actions performed by the user. A user's affinity may be computed by the online system 140 over time to approximate a user's interest in an object, a topic, or another user in the online system 140 based on the actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

One or more advertisement (“ad”) requests are included in the ad store 230. An ad request is received from an advertiser for presentation to users of the online system 140 and the ad request may be included in an advertisement campaign (“ad campaign”) by the advertiser. Each ad request includes advertisement content (“ad content”), which is ad content presented to an online system user. Ad content may be text data, image data, audio data, video data, or any other suitable data. Additionally, ad content may include a link or destination address associated with a source of content associated with the ad request that is presented to the user if the user accesses the ad content when it is presented. For example, the destination address identifies a landing page including content that is presented to the user when the user accesses the ad content.

Additionally, an ad request include a bid amount specifying an amount of compensation an advertiser associated with the ad request provides the online system 140 for presenting the ad content, for a user interacting with presented ad content, or for another suitable interaction with presented ad content by a user. Based on the bid amount included in an ad request, the online system 140 determines an expected value for presenting ad content in the ad request to a user. For example, the expected value is an amount of monetary compensation received by the online system 140 from an advertiser for presenting the advertisement to a user, for a user interacting with the presented ad content, or based on any other suitable condition. In one embodiment, the expected value of an ad request is a product of the bid amount and a probability of the ad content of the ad request being accessed by the user if presented.

A bid amount associated with an ad request may be based on a type associated with the ad request. The type associated with an ad request may be based at least in part on the format with which ad content included in the ad request is displayed or the type of information presented by the ad content. For example, a type of ad request includes ad content describing a single product or service. Another type of ad request includes ad content describing multiple products or services. Another type of ad request may include multiple components of ad content and an order in which the various components are presented to a user. A bid amount associated with an ad request may be proportional to the amount of different content included in the ad content. For example, a higher bid amount is associated with an ad request including ad content describing multiple products or services than is associated with an ad request including ad content describing a single product or service.

Additionally, ad requests may be associated with one or more targeting criteria. An advertiser may specify targeting criteria associated with an ad request or may specify targeting criteria associated with multiple ad requests included in an ad campaign. Targeting criteria specify one or more characteristics of users eligible to be presented with an ad content included in an ad request associated with the targeting criteria. Associating different targeting criteria with different ad requests allows an advertiser to tailor presentation of ad content to users having specific characteristics, allowing ad requests including different ad content to be presented to users with different characteristics. For example targeting criteria specify demographic information, connections, or actions associated with a user. In some embodiments, targeting criteria may be associated with an ad campaign in its entirety, so multiple ad requests in the ad campaign are associated with the targeting criteria.

In one embodiment, targeting criteria may specify actions or types of connections between a user and another user or object of the online system 140. Targeting criteria may also specify interactions between a user and objects performed external to the online system 140, such as on a third party system 130. For example, targeting criteria identifies users that have taken a particular action, such as sending a message to another user, using an application, joining a group, leaving a group, joining an event, generating an event description, purchasing or reviewing a product or service using an online marketplace, requesting information from a third party system 130, interacting with content on a third party system 130, or any other suitable action. Including actions in targeting criteria allows advertisers to further refine users eligible to be presented with ad content from various ad requests. As another example, targeting criteria identifies users having a connection to another user or object or having a particular type of connection to another user or object. For example, targeting criteria identifies users having previously performed a type of interaction with specified content maintained by the online system 140 or by a third party system 130. For example, targeting criteria identify a content item maintained by a third party system 130 and a type of interaction with the content item, so users previously preforming the type of interaction with the content item are eligible to be presented with ad content included in an ad request along with the targeting criteria. Using targeting criteria to identify content for presentation to users based on prior interactions by the user with content is further described in U.S. patent application Ser. No. 13/306,901, filed on Nov. 29, 2011, and U.S. patent application Ser. No. 14/177,300, filed on Nov. 21, 2013, both of which are hereby incorporated by reference in their entirety.

Additionally, an ad request may include an objective specifying a goal of the advertiser for presentation of the ad content in the ad request to online system users. The objective may also be associated with an ad campaign including the ad request to specify a goal of the advertiser for other ad requests in the ad campaign as well as the ad request. For example, the objective identifies a type of interaction with ad content from ad requests included in the ad campaign or with one or more objects associated with ad requests in the ad campaign by online system users presented with ad content from the ad campaign. Examples of objectives include: online system users accessing presented ad content (e.g., clicking or otherwise accessing the advertisement), online system users installing an application associated with the ad content, online system users expressing a preference for a page associated with the ad content (i.e., “liking” the page), online system users viewing a page associated with the ad content or with the ad campaign, or any other suitable action by online system users. In one embodiment, the objective is selected from a set of objectives maintained by the online system 140.

Additional information may be associated with an ad request or with the ad campaign including the ad request. For example, the ad request or ad campaign includes a budget that specifies a total amount of compensation an advertiser provides the online system 140 for presenting ad content included in the ad request or included in ad requests associated with an ad campaign. The budget may be allocated for the ad campaign as a whole or per ad request. In addition, the advertiser may specify instructions for allocating the budget among various ad requests in the ad campaign. For example, the instructions specify modification of a bid amount associated with an ad request included in the ad campaign based on one or more criteria. The instructions may also include other suitable information describing allocation of a budget among ad requests included in the ad campaign.

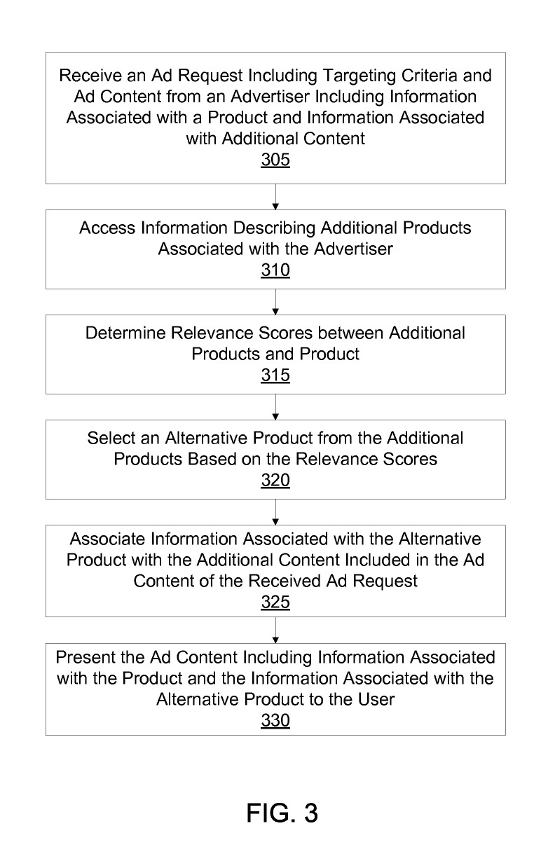

If the online system 140 receives a type of ad request including ad content describing a product or service and additional information for association with additional content, the ad generation module 235 may identify the additional content for presentation in the ad content. For example, an ad request includes information describing a product previously presented to a user identified by the ad request's targeting criteria and indicates that additional content is to be presented in the ad content. When the ad request is presented to the user via the online system 140, the ad generation module 235 determines the additional content and includes the additional content in the ad content presented to the user. In one embodiment, the ad generation module 235 retrieves information associated with additional products or services associated with a product identified in the ad request and selects one or more alternative products based on the product identified in the ad request or information associated with the user by the online system 140. For example, the ad generation module 235 determines relevance scores between a product or service identified in the ad request and additional products or services based on characteristics of the products or services or characteristics of the user. Based on the relevance scores, the ad generation module 235 selects one or more alternative products or services and includes information associated with the alternative products or services in the ad content presented to the user. Selection of alternative products or services presented via ad content associated with an ad request is further described below in conjunction with FIG. 3.

The web server 240 links the online system 140 via the network 120 to the one or more client devices 110, as well as to the one or more third party systems 130. The web server 140 serves web pages, as well as other web-related content, such as JAVA®, FLASH®, XML and so forth. The web server 240 may receive and route messages between the online system 140 and the client device 110, for example, instant messages, queued messages (e.g., email), text messages, short message service (SMS) messages, or messages sent using any other suitable messaging technique. A user may send a request to the web server 240 to upload information (e.g., images or videos) that are stored in the content store 210. Additionally, the web server 240 may provide application programming interface (API) functionality to send data directly to native client device operating systems, such as IOS®, ANDROID™, WEBOS® or BlackberryOS.

### Selecting Alternative Content Based on Relevance to Content in an Ad Request

FIG. 3 is a flowchart of one embodiment of a method for selecting an alternative product to include in advertisement (“ad”) content along with a product previously presented to a user of the online system 140. In other embodiments, rather than an alternative product, alternative content items can be selected to be presented along with a previously presented content item, along with a previously presented product, along with an alternative product, or any combination thereof. Additionally, the method described in conjunction with FIG. 3 may be used to select alternative content items along with a content item previously presented to the user or along with a content item with which the user previously interacted. In other embodiments, the method may include different and/or additional steps than those shown in FIG. 3. Additionally, steps of the method may be performed in different orders than the order described in conjunction with FIG. 3.

The online system 140 receives 305 an advertisement (“ad”) request including targeting criteria and ad content from an advertiser. The targeting criteria include information identifying a user of the online system 140. Example information identifying the user of the online system 140 includes: an online system user identifier associated with the user, a browser identifier associated with the user, a client device identifier associated with the user, an application identifier associated with the user, or other information capable of identifying a user of the online system 140 eligible to be presented with the advertisement content in the ad request. Alternatively, targeting criteria may identify one or more characteristics of online system users eligible to be presented with the ad content in the ad request. Example characteristics of users identified by targeting criteria include: a gender of the user, a location associated with the user (e.g., a hometown, a current location, a place visited by the user, a prior residence of the user), an occupation associated with the user, a connection between the user and an additional user or object, an action associated with the user, an action associated with another user connected to the user via the online system 140, an educational history of the user (e.g., schools attended), an age associated with the user or any other suitable information associated with the user by the online system 140.

The ad content of the ad request includes information associated with a product previously presented to the user by an entity associated with the advertiser and information associated with additional content. Additionally, the ad content may include a link associated with the product identifying a location from which additional information associated with the product is retrieved. For example, the link is a network address associated with an entity from which the product may be purchased or from which additional information about the product may be retrieved. The product may be an item sold by the advertiser, an item associated with the advertiser (e.g., sponsorship of the item), a service offered or provided by the advertiser, or any other suitable offer by the advertiser. Various characteristics are associated with the product. Example characteristics of the product previously presented to the user include: a name of the product, a price of the product, a manufacturer of the product, a merchant or advertiser selling the product, an entity associated with the advertiser, a type of product, a purpose of the product, and one or more features of the product. In some embodiments, one or more characteristics of the product describe performance of additional ad requests associated with the product or performance of additional ad requests associated with the advertiser. For example, a characteristic describes a conversion rate associated with ad requests associated with the advertiser, a conversion rate associated with ad requests associated with the product, a number of impressions of ad requests associated with the product, a number of impressions of ad requests associated with the advertiser, or any other suitable information.

The entity associated with the advertiser that previously presented the product to the user may be a third party system 130 on which information associated with the product was presented, a system associated with the advertiser, another user of the online system 140, or any other entity capable of providing information associated with the product. For example, if the entity is a third party system 130 and the user accesses the third party system 130 via a client device 110, the third party system 130 stores information on the client device 110, such as a cookie, indicating that the user accessed the third party system 130. If the user subsequently accesses the online system 140, the information stored on the client device is communicated to the online system 140 identifying the user as eligible to be presented with content from an advertiser associated with the third party system or from the third party system 130. The cookie may also identify content with which the user interacted via the third party system 130, such as an identifier associated with the product. This allows the third party system 130, or an advertiser associated with the third party system 130, to provide content to the user via the ad request based on the user's interaction with the third party system 130.

Information associated with the product included in the ad content may include social context information based on actions associated with users of the online system 140 connected with the user and associated with the product. For example, the information may identify one or more additional users of the online system 140 connected to the user indicating a preference for the product, purchasing the product, providing a comment associated with the product, or performing another action associated with the product. For example, the included information identifies an additional user connected to the user and an action associated with the additional user and associated with the product, such as text identifying the user and the action (e.g., “your friend X purchased this product”). Additionally, information associated with the product previously presented to the user may describe characteristics of the product, such as those described above in conjunction with FIG. 2.

Additionally, the ad content includes a link or destination address associated with the product. The link may be a network address or other information identifying a source of information associated with the product. For example, the link redirects a user of the online system 140 to a third party system 130 associated with the product where the user may purchase, access information describing, or interact with the product. Alternatively, the link may redirect the user to a third party system 130 associated with the advertiser or with an entity associated with the advertiser to access information describing the product. The link may be a link identifying information associated with the product or identifying the product and information for communication to the entity describing presentation of information associated with the product; for example, the link identifies an application associated with the entity and also includes instructions describing information to be presented when the application is executed. The ad content also includes information associated with additional content, such as characteristics of an additional product that has not previously been presented to the user.

In some embodiments, the online system 140 determines the information presented via the additional content. The online system 140 accesses 310 information describing one or more additional products associated with the advertiser or associated with an entity associated with the advertiser. In one embodiment, the online system 140 accesses 310 information maintained by the advertiser or a third party system 130 describing the one or more additional products. Additionally or alternatively, the online system 140 accesses 310 information maintained by the online system 140 and describing the additional products or accesses information describing user actions with the third party system 130. For example, the online system 140 accesses 310 information describing characteristics of one or more additional products. As described above in conjunction with FIG. 2, example characteristics of an additional product include: a name of the additional product, a price of the additional product, a manufacturer of the additional product, a merchant or an advertiser selling the additional product, an entity associated with the additional product, a type of the additional product, a purpose of the additional product, and one or more features of the additional product. Each additional product is associated with a link or destination address to access information associated with the additional product.

The additional products may be identified based in part on interactions between the user and the advertiser (e.g., searches for a product, requests for information about a product, etc.), products or services offered by the advertiser, and links associated with additional products redirect the user to the third party system 130 where the user performed one or more actions. In one example, the user visited a page of the online system 140 or of a third party system 130 associated with a travel company and searched for hotels in Australia. Information describing the search results may be maintained by the third party system 130 or communicated to the online system 140. The information included in the ad content may be associated with one or more of the results of the search for hotels or other products associated with the travel company, with a link including the ad content redirecting the user to the page of the online system 140 or of third party system 130 associated with the travel company. The additional products may be based on the search results, other products associated with the travel company, products associated with the search (e.g., plane ticket information, activities to do in Australia, car rental options, etc.), or any combination thereof. A link is associated with each additional product that also redirects the user to the page of the online system 140 or to a page of a third party system 130 associated with the travel company.

Relevance scores between the product previously presented to the user and various additional products are determined 315 by the online system 140. For example, the online system 140 determines 315 relevance scores between each additional product and the product previously presented to the user. In one embodiment, a relevance score between the product and an additional product is based on a number of characteristics of the product matching or similar to characteristics of the additional product. For example, a relevance score between the product an additional product is proportional to a number of characteristics of the product matching characteristics of the additional product. In some embodiments, the online system 140 maintains relationships between a characteristic and one or more additional characteristics and determines a characteristic being evaluated as matching one of the additional characteristics. Alternatively, weights are associated with different characteristics, and the relevance score between the product and the additional product is based on a combination of the weights associated with characteristics of the product matching characteristics of the additional product. Weights associated with characteristics may be specified by the advertiser from which the ad request was received or by the online system 140. If the online system 140 determines the weights, the weights may be based on a location associated with the user, interactions by online system users with one or more objects associated with the product, attributes associated with the user by the online system 140, actions associated with the user by the online system 140 or any other suitable information.

In another embodiment, a relevance score between the product and an additional product is determined 315 based at least in part on information associated with the user by the online system 140. For example, a relevance score between the product and an additional product is based on a number of characteristics of the additional product matching or similar to attributes associated with the user by the online system 140 (e.g., characteristics of the user, objects connected to the user via the online system 140, actions associated with the user by the online system 140, etc.). Alternatively, the online system 140 excludes comparison of certain characteristics of the product when determining 315 relevance scores based on information associated with the user by the online system 140. Information describing content from a third party system 130 with which the user interacted or actions performed by the user on the third party system 130 and communicated to the online system 140 may also be used to determine 315 relevance scores. For example, products associated with one or more actions performed by the user on a third party system 140 (e.g., products associated with search results from a search performed by the user on the third party system 140, products associated with the search results, etc.) have higher relevance stores than products that are not related to actions performed by the user on the third party system 140. In another embodiment, the online system 140 determines weights associated with various characteristics based on information associated with the user by the online system 140 (e.g., location, age, occupation, actions associated with the user, actions associated with users connected to the user, users connected to the user, etc.).

Based at least in part on the relevance scores, the online system 140 selects 320 one or more alternative products from the one or more additional products. In one embodiment, the alternative product is selected 320 as the additional product having a highest relevance score. In alternative embodiments, the alternative product is selected 320 as an additional product with at least a threshold relevance score. If the online system 140 selects 320 multiple alternative products from the additional products, the alternative products are selected 320 as additional products associated with at least a threshold relevance score. As another example, the online system 140 ranks the additional products based at least in part on their relevance scores and selects 320 additional products having at least a threshold position in the ranking as alternative products. Alternatively, one or more alternative products are selected 320 by the advertiser or otherwise identified by the advertiser associated with the ad request. For example, the alternative products are included in the ad request, or the advertiser communicates information identifying one or more alternative products to the online system 140 in response to a request from the online system 140. The online system 140 may alternatively access a product catalog associated with the advertiser and select 320 one or more alternative products in sequence, or at random, from the product catalog; in some embodiments, the online system 140 selects 320 alternative products from the product catalog based at least in part on characteristics of the product previously presented to the user.

The online system 140 associates 325 information associated with the alternative product with the additional content included in the ad content of the received ad request. Hence, the additional content included in the ad content acts as a placeholder for information describing additional products. This allows the ad content to present information describing the product as well as information describing alternative products to the user identified in the targeting criteria of the ad request. Information associated with the alternative product may be information describing the alternative product, information identifying one or more additional users of the online system 140 associated with an interaction with the alternative product, information associated with the alternative product by the online system 140, or a link or destination address for retrieving additional information associated with the alternative product.

The online system 140 presents 330 the ad content including information associated with the product and the information associated with the alternative product to the user. For example, the presented ad content displays information describing the product and information describing the alternative product adjacent to each other. In one embodiment, the ad content includes multiple tiles and presents information describing the product in a tile and presents information describing the additional product in an additional tile. Alternatively, the ad content is a scrollable interface, and information describing the product or the additional product is presented as the user navigates through the scrollable interface horizontally, vertically, or in any possible direction. For example, the user navigates through the ad content to transition from viewing information describing the product to viewing information describing the additional product. The information describing the product and the information describing the additional product may each include a link for retrieving additional information (or purchasing) the product and the additional product, respectively. Thus, selection of the information describing the product or the information describing alternative product in the presented ad content directs the user to an entity, such as a third party system 130, associated with the product or with the additional product, respectively.

While, FIG. 3 describes presentation of related products in an ad unit, but the steps described above may also be used to identify additional content for presentation to a user. For example, the online system 140 generates or receives a content item including content and information including additional content that has not been presented to the user. Based on information associated with the user, such as actions associated with the user and other content presented by the user, the online system 140 determines additional content items for presentation to the user and identifies the additional content using the information including the additional content. For example, the online system 140 extracts a topic from the content in the content item, which may be a content with which the user previously interacted (e.g., a news article from a third party system 130 the user viewed, a status update for which the user indicated a preference), and determines relevance scores between additional content items having a topic matching or similar to the extracted topic as described above. Based on the relevance scores, the online system 140 selects one or more additional content items, which are identified in the content item. For example, a title or topic of an additional content item is presented in the content item along with a link to retrieve the additional content item.

### Example Advertisement Content Including Content and Alternative Content Presented to a User

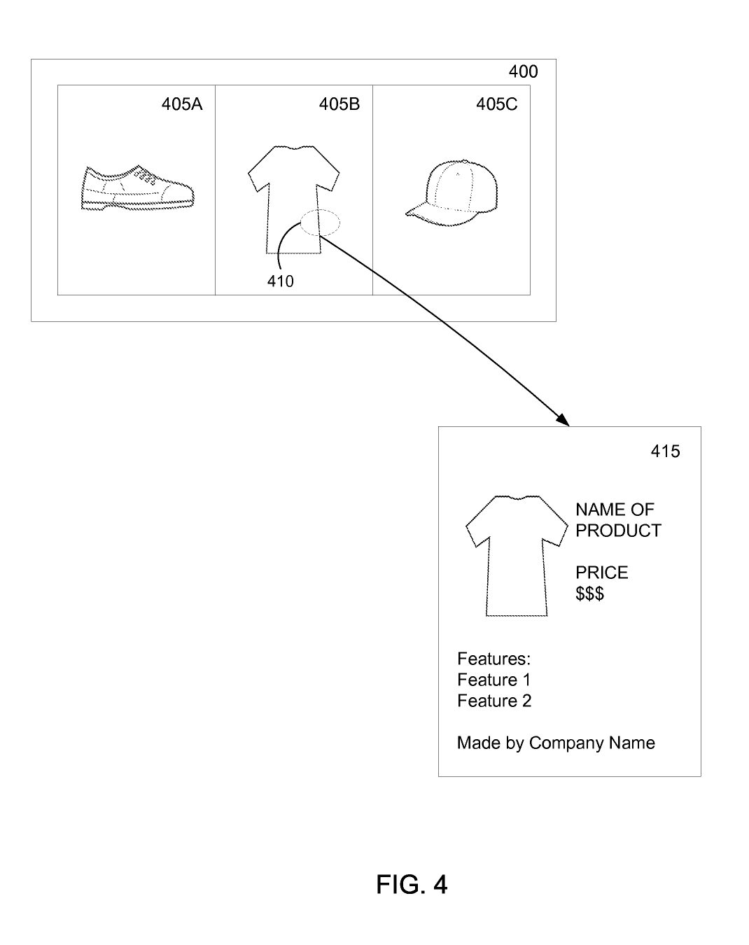

FIG. 4 is an example of advertisement (“ad”) content 400 presented to a user of an online system 140. In the example, the ad content 400 displays products such as a shoe, a shirt, and a hat where the products are associated with an advertiser associated with the ad content 400. The shoe is a product previously presented to the online system user and the alternative products were selected as described in conjunction with FIG. 3.

The ad content 400 displays information 405A, 405B, and 405C associated with the product and alternative products, respectively. Information 405A includes an image of the shoe (i.e., product previously presented to the user) and a link to access the shoe. Information 405B includes an image of the shirt or alternative product associated with the shoe that was previously presented to the user and a link for retrieving additional information about the shirt. Similarly, information 405C includes an image of the hat or alternative product associated with the shoe that was previously presented to the user and a link for retrieving additional information about the hat. Selection 410 of the information 405A describing the product or the information 405B or 405C describing alternative products in the presented ad content 400 directs the user to an entity, such as a third party system 130, associated with the product or with the corresponding alternative product, respectively. In the example shown, the user selects 410 information 405B of an alternative product and is redirected to a page or site 415 (e.g., on a third party system 130) displaying additional information to purchase the alternative product.

### SUMMARY

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
receiving an advertisement (“ad”) request including targeting criteria and ad content at an online system from an advertiser, the targeting criteria including information identifying a user of the online system, and the ad content including information associated with a product previously presented to the user by an entity associated with the advertiser, a link to access the product, and information associated with additional content;
accessing information describing one or more additional products associated with the advertiser, each additional product associated with a link to access the additional product;
determining relevance scores between each of the one or more additional products and the product;
selecting, by the online system, an alternative product from the one or more additional products based at least in part on the relevance scores;
associating information associated with the alternative product with the additional content included in the ad content of the received ad request; and
sending for display to the user the ad content including information associated with the product and the information associated with the alternative product.

2. The method of claim 1, wherein information identifying the user of the online system comprises information the user previously accessed information associated with the product via the entity.

3. The method of claim 1, wherein determining relevance scores between each of the one or more additional products and the product comprises:
retrieving one or more characteristics associated with the product;
identifying an additional product;
retrieving one or more characteristics associated with the additional product; and
determining a relevance score between the product and the additional product based at least in part on a number of characteristics associated with the product matching characteristics associated with the additional product.

4. The method of claim 3, wherein a characteristic associated with the product is selected from a group consisting of: a name of the product, a price of the product, a manufacturer of the product, a merchant selling the product, a type of the product, a purpose of the product, a feature of the product, and any combination thereof.

5. The method of claim 3, wherein a characteristic associated with the additional product is selected from a group consisting of: a name of the product, a price of the product, a manufacturer of the product, a merchant selling the product, a type of the product, a purpose of the product, a feature of the product, and any combination thereof.

6. The method of claim 1, wherein determining relevance scores between each of the one or more additional products and the product comprises:
retrieving one or more characteristics associated with the product;
identifying an additional product;
associating weights with each of the one or more characteristics associated with the product;
retrieving one or more characteristics associated with the additional product; and
determining a relevance score between the product and the additional product based at least in part on weights associated with characteristics associated with the product matching characteristics associated with the additional product.

7. The method of claim 6, wherein a weight associated with a characteristic associated with the product is specified by the advertiser.

8. The method of claim 6, wherein a weight associated with a characteristic associated with the product is determined by the online system based at least in part on information associated with the user by the online system.

9. The method of claim 8, wherein the information associated with the user by the online system is selected from a group consisting of: a location, a gender, an occupation, actions associated with the user, additional users connected to the user, objects associated with the user, and any combination thereof.

10. The method of claim 1, wherein determining relevance scores between each of the one or more additional products and the product comprises:
retrieving attributes associated with the user by the online system;
identifying an additional product;
retrieving one or more characteristics associated with the additional product; and
determining a relevance score between the product and the additional product based at least in part on attributes associated with the user by the online system matching characteristics associated with the additional product.

11. The method of claim 1, wherein selecting the alternative product from the one or more additional products based at least in part on the relevance scores comprises:
selecting an additional product associated with a maximum relevance score as the alternative product.

12. The method of claim 1, wherein selecting the alternative product from the one or more additional products based at least in part on the relevance scores comprises:
selecting an additional product associated with at least a threshold relevance score as the alternative product.

13. The method of claim 1, wherein selecting the alternative product from the one or more additional products based at least in part on the relevance scores comprises:
ranking the additional products based at least in part on the relevance scores; and
selecting an additional product associated with at least a threshold position in the ranking as the alternative product.

14. The method of claim 1, wherein the information associated with the alternative product includes a link to access additional information associated with the alternative product.

15. A method comprising:
receiving an advertisement (“ad”) request including targeting criteria and ad content at an online system from an advertiser, the targeting criteria including information identifying a user of the online system and ad content including information associated with a product previously presented to the user by an entity associated with the advertiser, a link to access the product, and information associated with additional content;
selecting one or more additional products associated with the advertiser, an additional product associated with a link to access information associated with the additional product;
associating information associated with the one or more additional products with the additional content included in the ad content of the received ad request; and
presenting the ad content including information associated with the product and the information associated with the one or more additional products to the user.

16. The method of claim 15, wherein information identifying the user of the online system comprises information the user previously accessed information associated with the product via the entity.

17. The method of claim 15, wherein selecting one or more additional products associated with the advertiser comprises:
receiving information identifying the one or more additional products from the advertiser.

18. The method of claim 15, wherein selecting one or more additional products associated with the advertiser comprises:
accessing information describing the one or more additional products associated with the advertiser, each additional product associated with a link to access the additional product;
determining relevance scores between each of the one or more additional products and the product; and
selecting one or more alternative products from the one or more additional products based at least in part on the relevance scores.

19. A computer program product comprising a computer-readable storage medium having instructions encoded thereon that, when executed by a processor, cause the processor to:
receive an advertisement (“ad”) request including targeting criteria and ad content at an online system from an advertiser, the targeting criteria including information identifying a user of the online system and ad content including information associated with a product previously presented to the user by an entity associated with the advertiser, a link to access the product, and information associated with additional content;
select one or more additional products associated with the advertiser, an additional product associated with a link to access information associated with the additional product;
associate information associated with the one or more additional products with the additional content included in the ad content of the received ad request; and
present the ad content including information associated with the product and the information associated with the one or more additional products to the user.

20. The computer program product of claim 19, wherein select one or more additional products associated with the advertiser comprises:
access information describing the one or more additional products associated with the advertiser, each additional product associated with a link to access the additional product;
determine relevance scores between each of the one or more additional products and the product; and
select one or more alternative products from the one or more additional products based at least in part on the relevance scores.
